(19) United States
(12) Patent Application Publication
(10) Pub. No.: US 2024/0037272 A1
(43) Pub. Date: Feb. 1, 2024

(54) SYSTEMS AND METHODS FOR ACTIVE ALGORITHM TRAINING IN A ZERO-TRUST ENVIRONMENT

(71) Applicant: BeeKeeperAI, Inc., Austin, TX (US)

(72) Inventors: Mary Elizabeth Chalk, Austin, TX (US); Robert Derward Rogers, Oakland, CA (US); Alan Donald Czeszynski, Pleasanton, CA (US)

(21) Appl. No.: 18/353,071

(22) Filed: Jul. 15, 2023

Related U.S. Application Data
(63) Continuation of application No. 18/352,874, filed on Jul. 14, 2023.
(60) Provisional application No. 63/393,639, filed on Jul. 29, 2022.

(51) Int. Cl. G06F 21/62; G06N 20/00

(52) U.S. Cl. CPC G06F 21/6245; G06N 20/00; G06F 21/629

(57) ABSTRACT

Systems and methods for providing algorithm performance feedback to an algorithm developer is provided In some embodiments, an algorithm and a data set are receiving within a secure computing node. The data set is processed using the algorithm to generate an algorithm output. A raw performance model is generated by regression modeling the algorithm output. The raw performance model is then smoothed to generate a final performance model, which is then encrypted and routed to an algorithm developer for further analysis. The performance model models at least one of the algorithm's accuracy, F1 score accuracy, precision, recall, dice score, ROC (receiver operator characteristic) curve/area, log loss, Jaccard index, error, R² or by some combination thereof. The regression modeling includes linear least squares, logistic regression, deep learning or some combination thereof.

### CROSS REFERENCE TO RELATED APPLICATION

This Application, (Attorney Docket No. BKP-2203-B), entitled “Systems And Methods For Active Algorithm Training In A Zero-Trust Environment”, is a Continuation Application and claims priority to U.S. application Ser. No. 18/352,874, (Attorney Docket No. BKP-2203-A), entitled “Systems And Methods For Algorithm Performance Modeling In A Zero-Trust Environment”, filed on Jul. 14, 2023, the contents of which is incorporated herein in its entirety by this reference.

Application Ser. No. 18/352,874, (Attorney Docket No. BKP-2203-A), entitled “Systems And Methods For Algorithm Performance Modeling In A Zero-Trust Environment”, filed on Jul. 14, 2023, claims the benefit and priority of U.S. Provisional Application No. 63/393,639, (Attorney Docket BKP-2203-P), entitled “Systems And Methods For Algorithm Performance Feedback In A Zero-Trust Environment”, filed Jul. 29, 2022, currently pending, the contents of which is incorporated herein in its entirety by this reference.

### BACKGROUND

The present invention relates in general to the field of zero-trust computing, and more specifically to methods, computer programs and systems for federated feedback in a zero-trust environment. Such systems and methods are particularly useful in situations where algorithm developers wish to maintain secrecy of their algorithms, and the data being processed is highly sensitive, such as protected health information. For avoidance of doubt, an algorithm may include a model, code, pseudo-code, source code, or the like.

Within certain fields, there is a distinguishment between the developers of algorithms (often machine learning of artificial intelligence algorithms), and the stewards of the data that said algorithms are intended to operate with and be trained by. On its surface this seems to be an easily solved problem of merely sharing either the algorithm or the data that it is intended to operate with. However, in reality, there is often a strong need to keep the data and the algorithm secret. For example, the companies developing their algorithms may have the bulk of their intellectual property tied into the software comprising the algorithm. For many of these companies, their entire value may be centered in their proprietary algorithms. Sharing such sensitive data is a real risk to these companies, as the leakage of the software base code could eliminate their competitive advantage overnight.

One could imagine that instead; the data could be provided to the algorithm developer for running their proprietary algorithms and generation of the attendant reports. However, the problem with this methodology is two-fold. Firstly, often the datasets for processing and extremely large, requiring significant time to transfer the data from the data steward to the algorithm developer. Indeed, sometimes the datasets involved consume petabytes of data. The fastest fiber optics internet speed in the US is 2,000 MB/second. At this speed, transferring a petabyte of data can take nearly seven days to complete. It should be noted that most commercial internet speeds are a fraction of this maximum fiber optic speed.

The second reason that the datasets are not readily shared with the algorithm developers is that the data itself may be secret in some manner. For example, the data could also be proprietary, being of a significant asset value. Moreover, the data may be subject to some control or regulation. This is particularly true in the case of medical information. Protected health information, or PHI, for example, is subject to a myriad of laws, such as HIPAA, that include strict requirements on the sharing of PHI, and are subject to significant fines if such requirements are not adhered to.

Healthcare related information is of particular focus of this application. Of all the global stored data, about 30% resides in healthcare. This data provides a treasure trove of information for algorithm developers to train their specific algorithm models (AI or otherwise), and allows for the identification of correlations and associations within datasets. Such data processing allows advancements in the identification of individual pathologies, public health trends, treatment success metrics, and the like. Such output data from the running of these algorithms may be invaluable to individual clinicians, healthcare institutions, and private companies (such as pharmaceutical and biotechnology companies). At the same time, the adoption of clinical AI has been slow. More than 12,000 life-science papers described AI and ML in 2019 alone. Yet the U.S. Food and Drug Administration (FDA) has only approved only slightly more than 30 AI/ML-based medical technologies to date. Data access is a major barrier to clinical approval. The FDA requires proof that a model works across the entire population. However, privacy protections make it challenging to access enough diverse data to accomplish this goal.

For many of the same reasons as it is difficult to share the PHI and/or algorithms between the parties, the sharing of performance data from the operation of the algorithms poses similar challenges. This is important because data regarding algorithm performance is necessary for tuning models, for performance tracking, generating of command sets for the algorithm operation, and for regulatory and other similar purposes.

Given that there is great value in the operation of secret algorithms on data that also must remain secret, there is a significant need for systems and methods that allow for such zero-trust operations. Within such zero trust environments there is likewise a need for the ability to provide performance data back to the algorithm developer without them gaining access to any of the patient data operated upon by the algorithm. Such systems and methods enable sensitive data to be analyzed in a secure environment and performance data to be generated, while maintaining secrecy of both the algorithms involved, as well as the personal health data.

### SUMMARY

The present systems and methods relate to performance tracking within a secure and zero-trust environment. Such systems and methods enable improvements in the ability to improve and train algorithms without the possibility of the underlying personal health information being shared with any other party than the original data steward.

In some embodiments, an algorithm and a data set are receiving within a secure computing node. The data set is processed using the algorithm to generate an algorithm output. A raw performance model is generated by regression modeling the algorithm output. The raw performance model is then smoothed to generate a final performance model, which is then encrypted and routed to an algorithm developer for further analysis.

The performance model models at least one of the algorithm's accuracy, F1 score accuracy, precision, recall, dice score, ROC (receiver operator characteristic) curve/area, log loss, Jaccard index, error, R² or by some combination thereof. The regression modeling includes linear least squares, logistic regression, deep learning or some combination thereof.

The smoothing includes identifying portions of the raw performance model which are highly variable. The smoothing includes best fit transform, moving averages and application of filters, Loess smoothing, kernel smoothing, wavelets, splines or some combination thereof. In some cases the smoothing weights the data points of the raw performance model by instances of the algorithm's input variables.

It is possible that the algorithm developer receives multiple final performance models from the algorithm operating on a plurality of data sets. The algorithm developer then is able to identify perturbations in the multiple final performance models. It is also possible to identify portions of the final performance model with lower performance and provides feedback to a data steward to generate more training data for variables in the data set associated with said portions.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIGS. 1A and 1B are example block diagrams of a system for zero trust computing of data by an algorithm, in accordance with some embodiment;

FIG. 2 is an example block diagram showing the core management system, in accordance with some embodiment;

FIG. 3 is an example block diagram showing a first model for the zero-trust data flow, in accordance with some embodiment;

FIG. 4 is an example block diagram showing a model for the zero-trust data flow with performance tracking, in accordance with some embodiment;

FIG. 5 is an example block diagram showing a runtime server, in accordance with some embodiment;

FIG. 6 is a flowchart for an example process for the operation of the zero-trust data processing system, in accordance with some embodiment;

FIG. 7A a flowchart for an example process of acquiring and curating data, in accordance with some embodiment;

FIG. 7B a flowchart for an example process of onboarding a new host data steward, in accordance with some embodiment;

FIG. 8 is a flowchart for an example process of encapsulating the algorithm and data, in accordance with some embodiment;

FIG. 9 is a flowchart for an example process of a first model of algorithm encryption and handling, in accordance with some embodiment;

FIG. 10 is a flowchart for an example process of a second model of algorithm encryption and handling, in accordance with some embodiments;

FIG. 11 is a flowchart for an example process of a third model of algorithm encryption and handling, in accordance with some embodiments;

FIG. 12 is an example block diagram showing the training of the model within a zero-trust environment, in accordance with some embodiments;

FIG. 13 is a flowchart for an example process of training of the model within a zero-trust environment, in accordance with some embodiments;

FIG. 14 is a flowchart for an example process of algorithm performance tracking, in accordance with some embodiments;

FIG. 15 is a flow diagram for the example process of performance model generation, in accordance with some embodiments;

FIG. 16 is a flow diagram for the example process of model perturbation identification, in accordance with some embodiments;

FIG. 17 is a flow diagram for the example process of algorithm improvement, in accordance with some embodiments;

FIGS. 18A-C are example graphs exemplifying performance model outputs, in accordance with some embodiments; and

FIGS. 19A and 19B are illustrations of computer systems capable of implementing the zero-trust computing, in accordance with some embodiments.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

The present invention relates to systems and methods for the zero-trust application on one or more algorithms processing sensitive datasets. Such systems and methods may be applied to any given dataset, but may have particular utility within the healthcare setting, where the data is extremely sensitive. As such, the following descriptions will center on healthcare use cases. This particular focus, however, should not artificially limit the scope of the invention. For example, the information processed may include sensitive industry information, financial, payroll or other personally identifiable information, or the like. As such, while much of the disclosure will refer to protected health information (PHI) it should be understood that this may actually refer to any sensitive type of data. Likewise, while the data stewards are generally thought to be a hospital or other healthcare entity, these data stewards may in reality be any entity that has and wishes to process their data within a zero-trust environment.

In some embodiments, the following disclosure will focus upon the term “algorithm”. It should be understood that an algorithm may include machine learning (ML) models, neural network models, or other artificial intelligence (AI) models. However, algorithms may also apply to more mundane model types, such as linear models, least mean squares, or any other mathematical functions that convert one or more input values, and results in one or more output models.

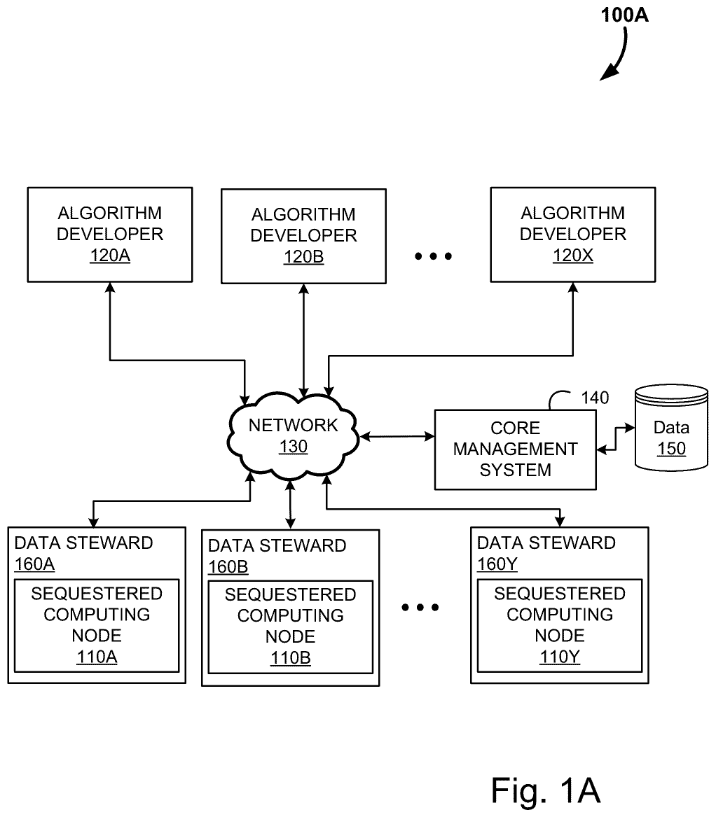

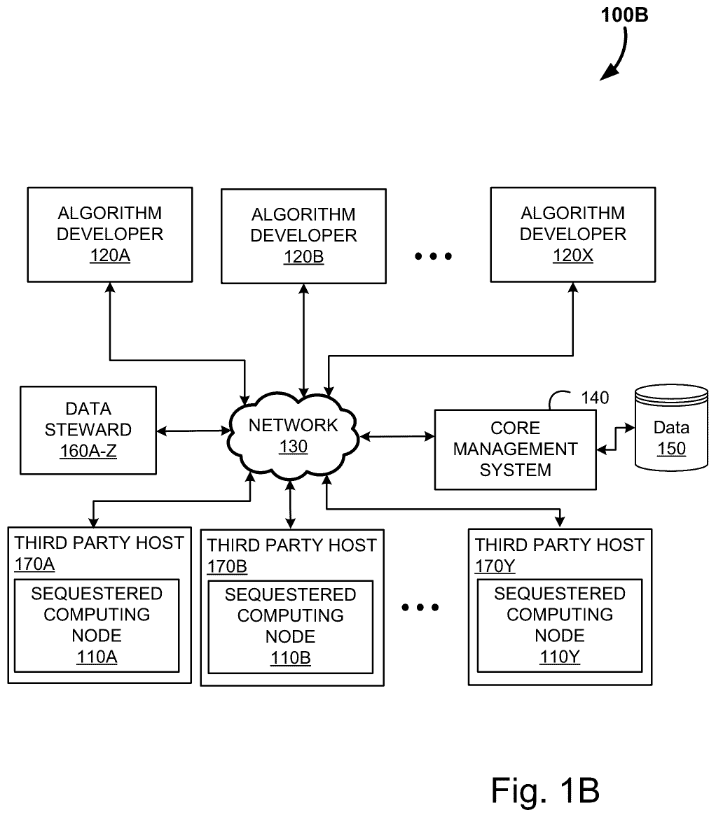

Also, in some embodiments of the disclosure, the terms “node”, “infrastructure” and “enclave” may be utilized. These terms are intended to be used interchangeably and indicate a computing architecture that is logically distinct (and often physically isolated). In no way does the utilization of one such term limit the scope of the disclosure, and these terms should be read interchangeably. To facilitate discussions, FIG. 1A is an example of a zero-trust infrastructure, shown generally at 100a. This infrastructure includes one or more algorithm developers 120a-x which generate one or more algorithms for processing of data, which in this case is held by one or more data stewards 160a-y. The algorithm developers are generally companies that specialize in data analysis, and are often highly specialized in the types of data that are applicable to their given models/algorithms. However, sometimes the algorithm developers may be individuals, universities, government agencies, or the like. By uncovering powerful insights in vast amounts of information, AI and machine learning (ML) can improve care, increase efficiency, and reduce costs. For example, AI analysis of chest x-rays predicted the progression of critical illness in COVID-19. In another example, an image-based deep learning model developed at MIT can predict breast cancer up to five years in advance. And yet another example is an algorithm developed at University of California San Francisco, which can detect pneumothorax (collapsed lung) from CT scans, helping prioritize and treat patients with this life-threatening condition—the first algorithm embedded in a medical device to achieve FDA approval.

Likewise, the data stewards may include public and private hospitals, companies, universities, governmental agencies, or the like. Indeed, virtually any entity with access to sensitive data that is to be analyzed may be a data steward.

The generated algorithms are encrypted at the algorithm developer in whole, or in part, before transmitting to the data stewards, in this example ecosystem. The algorithms are transferred via a core management system 140, which may supplement or transform the data using a localized datastore 150. The core management system also handles routing and deployment of the algorithms. The datastore may also be leveraged for key management in some embodiments that will be discussed in greater detail below.

Each of the algorithm developer 120a-x, and the data stewards 160a-y and the core management system 140 may be coupled together by a network 130. In most cases the network is comprised of a cellular network and/or the internet. However, it is envisioned that the network includes any wide area network (WAN) architecture, including private WAN's, or private local area networks (LANs) in conjunction with private or public WANs.

In this particular system, the data stewards maintain sequestered computing nodes 110a-y which function to actually perform the computation of the algorithm on the dataset. The sequestered computing nodes, or “enclaves”, may be physically separate computer server systems, or may encompass virtual machines operating within a greater network of the data steward's systems. The sequestered computing nodes should be thought of as a vault. The encrypted algorithm and encrypted datasets are supplied to the vault, which is then sealed. Encryption keys 390 unique to the vault are then provided, which allows the decryption of the data and models to occur. No party has access to the vault at this time, and the algorithm is able to securely operate on the data. The data and algorithms may then be destroyed, or maintained as encrypted, when the vault is “opened” in order to access the report/output derived from the application of the algorithm on the dataset. Due to the specific sequestered computing node being required to decrypt the given algorithm(s) and data, there is no way they can be intercepted and decrypted. This system relies upon public-private key techniques, where the algorithm developer utilizes the public key 390 for encryption of the algorithm, and the sequestered computing node includes the private key in order to perform the decryption. In some embodiments, the private key may be hardware (in the case of Azure, for example) or software linked (in the case of AWS, for example).

In some particular embodiments, the system sends algorithm models via an Azure Confidential Computing environment to two data steward environments. Upon verification, the model and the data entered the Intel SGX sequestered enclave where the model is able to be validated against the protected information, for example PHI, data sets. Throughout the process, the algorithm owner cannot see the data, the data steward cannot see the algorithm model, and the management core can see neither the data nor the model.

The data steward uploads encrypted data to their cloud environment using an encrypted connection that terminates inside an Intel SGX-sequestered enclave. Then, the algorithm developer submits an encrypted, containerized AI model which also terminates into an Intel SGX-sequestered enclave. A key management system in the management core enables the containers to authenticate and then run the model on the data within the enclave. The data steward never sees the algorithm inside the container and the data is never visible to the algorithm developer. Neither component leaves the enclave. After the model runs, the developer receives a performance report on the values of the algorithm's performance (as will be discussed in considerable detail below). Finally, the algorithm owner may request that an encrypted artifact containing information about validation results is stored for regulatory compliance purposes and the data and the algorithm are wiped from the system.

FIG. 1B provides a similar ecosystem 100b. This ecosystem also includes one or more algorithm developers 120a-x, which generate, encrypt and output their models. The core management system 140 receives these encrypted payloads, and in some embodiments, transforms or augments unencrypted portions of the payloads. The major difference between this substantiation and the prior figure, is that the sequestered computing node(s) 110a-y are present within a third party host 170a-y. An example of a third-party host may include an offsite server such as Amazon Web Service (AWS) or similar cloud infrastructure. In such situations, the data steward encrypts their dataset(s) and provides them, via the network, to the third party hosted sequestered computing node(s) 110a-y. The output of the algorithm running on the dataset is then transferred from the sequestered computing node in the third-party, back via the network to the data steward (or potentially some other recipient).

In some specific embodiments, the system relies on a unique combination of software and hardware available through Azure Confidential Computing. The solution uses virtual machines (VMs) running on specialized Intel processors with Intel Software Guard Extension (SGX), in this embodiment, running in the third party system. Intel SGX creates sequestered portions of the hardware's processor and memory known as “enclaves” making it impossible to view data or code inside the enclave. Software within the management core handles encryption, key management, and workflows.

In some embodiments, the system may be some hybrid between FIGS. 1A and 1B. For example, some datasets may be processed at local sequestered computing nodes, especially extremely large datasets, and others may be processed at third parties. Such systems provide flexibility based upon computational infrastructure, while still ensuring all data and algorithms remain sequestered and not visible except to their respective owners.

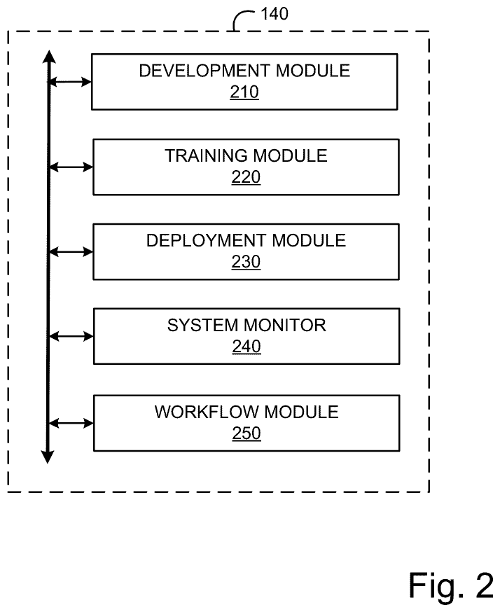

Turning now to FIG. 2, greater detail is provided regarding the core management system 140. The core management system 140 may include a data science development module 210, a data harmonizer workflow creation module 250, a software deployment module 230, a federated master algorithm training module 220, a system monitoring module 240, and a data store comprising global join data 240.

The data science development module 210 may be configured to receive input data requirements from the one or more algorithm developers for the optimization and/or validation of the one or more models. The input data requirements define the objective for data curation, data transformation, and data harmonization workflows. The input data requirements also provide constraints for identifying data assets acceptable for use with the one or more models. The data harmonizer workflow creation module 250 may be configured to manage transformation, harmonization, and annotation protocol development and deployment. The software deployment module 230 may be configured along with the data science development module 210 and the data harmonizer workflow creation module 250 to assess data assets for use with one or more models. This process can be automated or can be an interactive search/query process. The software deployment module 230 may be further configured along with the data science development module 210 to integrate the models into a sequestered capsule computing framework, along with required libraries and resources.

In some embodiments, it is desired to develop a robust, superior algorithm/model that has learned from multiple disjoint private data sets (e.g., clinical and health data) collected by data hosts from sources (e.g., patients). The federated master algorithm training module may be configured to aggregate the learning from the disjoint data sets into a single master algorithm. In different embodiments, the algorithmic methodology for the federated training may be different. For example, sharing of model parameters, ensemble learning, parent-teacher learning on shared data and many other methods may be developed to allow for federated training. The privacy and security requirements, along with commercial considerations such as the determination of how much each data system might be paid for access to data, may determine which federated training methodology is used.

The system monitoring module 240 monitors activity in sequestered computing nodes. Monitored activity can range from operational tracking such as computing workload, error state, and connection status as examples to data science monitoring such as amount of data processed, algorithm convergence status, variations in data characteristics, data errors, algorithm/model performance metrics, and a host of additional metrics, as required by each use case and embodiment.

In some instances, it is desirable to augment private data sets with additional data located at the core management system (join data 150). For example, geolocation air quality data could be joined with geolocation data of patients to ascertain environmental exposures. In certain instances, join data may be transmitted to sequestered computing nodes to be joined with their proprietary datasets during data harmonization or computation.

The sequestered computing nodes may include a harmonizer workflow module, harmonized data, a runtime server, a system monitoring module, and a data management module (not shown). The transformation, harmonization, and annotation workflows managed by the data harmonizer workflow creation module may be deployed by and performed in the environment by harmonizer workflow module using transformations and harmonized data. In some instances, the join data may be transmitted to the harmonizer workflow module to be joined with data during data harmonization. The runtime server may be configured to run the private data sets through the algorithm/model.

The system monitoring module monitors activity in the sequestered computing node. Monitored activity may include operational tracking such as algorithm/model intake, workflow configuration, and data host onboarding, as required by each use case and embodiment. The data management module may be configured to import data assets such as private data sets while maintaining the data assets within the pre-exiting infrastructure of the data stewards.

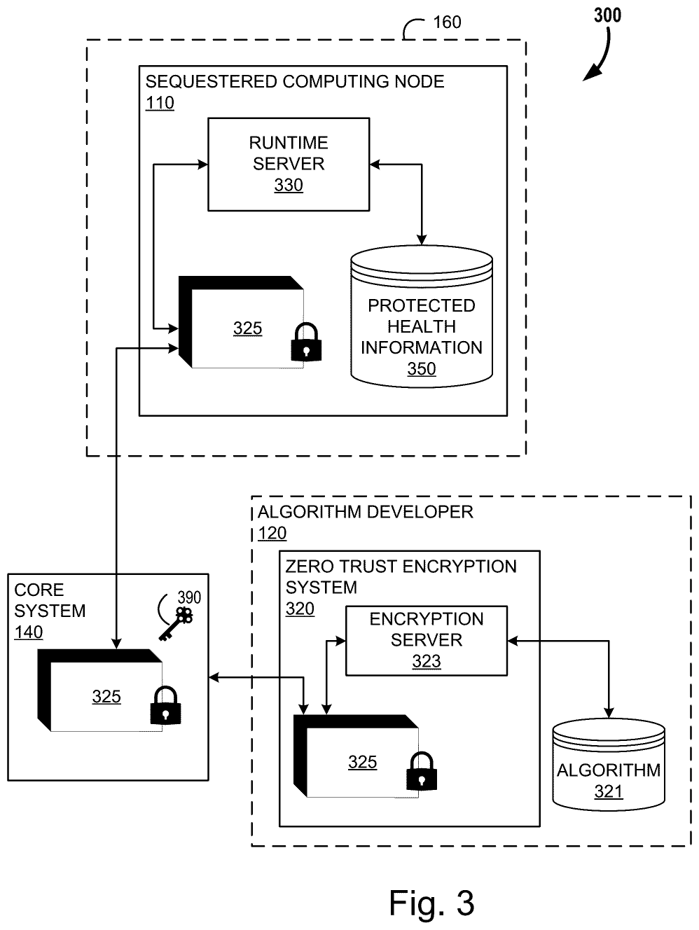

Turning now to FIG. 3, a first model of the flow of algorithms and data are provided, generally at 300. The Zero-Trust Encryption System 320 manages the encryption, by an encryption server 323, of all the algorithm developer's 120 software assets 321 in such a way as to prevent exposure of intellectual property (including source or object code) to any outside party, including the entity running the core management system 140 and any affiliates, during storage, transmission and runtime of said encrypted algorithms 325. In this embodiment, the algorithm developer is responsible for encrypting the entire payload 325 of the software using its own encryption keys. Decryption is only ever allowed at runtime in a sequestered capsule computing environment 110.

The core management system 140 receives the encrypted computing assets (algorithms) 325 from the algorithm developer 120. Decryption keys to these assets are not made available to the core management system 140 so that sensitive materials are never visible to it. The core management system 140 distributes these assets 325 to a multitude of data steward nodes 160 where they can be processed further, in combination with private datasets, such as protected health information (PHI) 350.

Each Data Steward Node 160 maintains a sequestered computing node 110 that is responsible for allowing the algorithm developer's encrypted software assets 325 (the “algorithm” or “algo”) to compute on a local private dataset 350 that is initially encrypted. Within data steward node 160, one or more local private datasets (not illustrated) is harmonized, transformed, and/or annotated and then this dataset is encrypted by the data steward, into a local dataset 350, for use inside the sequestered computing node 110.

The sequestered computing node 110 receives the encrypted software assets 325 and encrypted data steward dataset(s) 350 and manages their decryption in a way that prevents visibility to any data or code at runtime at the runtime server 330. In different embodiments this can be performed using a variety of secure computing enclave technologies, including but not limited to hardware-based and software-based isolation.

In this present embodiment, the entire algorithm developer software asset payload 325 is encrypted in a way that it can only be decrypted in an approved sequestered computing enclave/node 110. This approach works for sequestered enclave technologies that do not require modification of source code or runtime environments in order to secure the computing space (e.g., software-based secure computing enclaves).

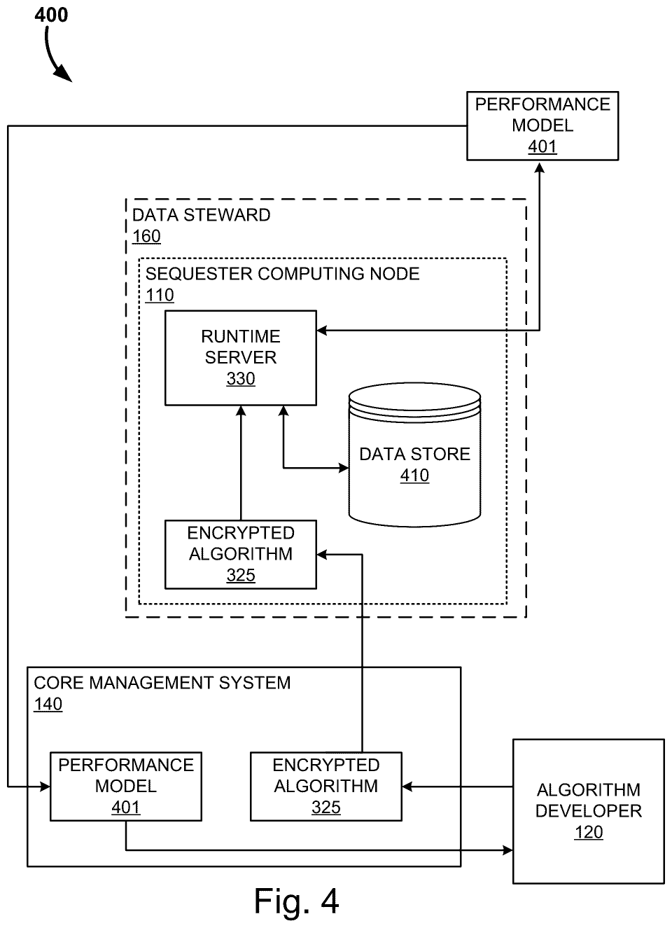

Turning to FIG. 4, the general environment is maintained, as seen generally at 400, however in this embodiment the flow of the IP assets is illustrated in greater detail. In this example diagram, the Algorithm developer 120 generates an algorithm, which is then encrypted and provided as an encrypted algorithm payload 325 to the core management system 140. As discussed previously, the core management system 140 is incapable of decrypting the encrypted algorithm 325. Rather, the core management system 140 controls the routing of the encrypted algorithm 325 and the management of keys. The encrypted algorithm 325 is then provided to the data steward 160 which is then “placed” in the sequestered computing node 110. The data steward 160 is likewise unable to decrypt the encrypted algorithm 325 unless and until it is located within the sequestered computing node 110, in which case the data steward still lacks the ability to access the “inside” of the sequestered computing node 110. As such, the algorithm is never accessible to any entity outside of the algorithm developer.

Likewise, the data steward 160 has access to protected health information and/or other sensitive information. The data steward 160 never transfers this data outside of its ecosystem, thus ensuring that the data is always inaccessible by any other party. The sensitive data may be encrypted (or remain in the clear) as it is also transferred into the sequestered computing node 110. This data store 410 is made accessible to the runtime server 330 also located “inside” the sequestered computing node 110. The runtime server 330 decrypts the encrypted algorithm 325 to yield the underlying algorithm model. This algorithm may then use the data store 410 to generate inferences regarding the date contained in the data store 410 (not illustrated). These inferences have value for the data steward 110, and may be outputted to the data steward for consumption.

The runtime server 330 may also perform a number of other operations. One critical operation that is the focus of this present disclosure is the generation of a performance model 401. The performance model 401 is a regression model generated based upon the inferences derived from the algorithm. The performance model 401 is generated by any one of a number of possible regression methods, such as linear least squares, logistic regression, deep learning, etc. Specifically, for all labeled data points in the validation data set (e.g., data points that are used to evaluate the performance of the algorithm independent of the training process), the inference of the algorithm developer's algorithm is computed and compared with the label for that input point. A local averaging technique is used around each point to compute a “local” performance metric for the algorithm developer's algorithm. This local metric could be any algorithm performance measure, as described above, including but not limited to error rate, entropy, F1 score, dice score, etc. The performance model 401 is constructed from each of these input data points and the corresponding “local” performance value for that point by training a regression model to predict the “local” performance as a function of the inputs. This model essentially predicts the expected performance of the original algorithm for any region of the input space that has been sampled. The choice of kernel or smoothing function for computing the “local” performance is constrained to minimize the amount of information that can be inferred about the distribution of underlying input data points, ensuring that no private data will be exposed by the performance model 401.

The performance model 401 provides data regarding the performance of the algorithm based upon the various inputs. For a single variable input the performance model 401 would appear as a simple line function. For two variables, the performance model 401 would present as a surface. As the number of variables increases, the performance model 401 abstracts into a multidimensional space that is incomprehensible to a human mind but is able to be modeled by a computer system. The performance model 401 may model for algorithm accuracy, F1 score, precision, recall, dice score, ROC (receiver operator characteristic) curve/area, log loss, Jaccard index, error, R² or by some combination thereof.

The performance model 401, by its nature, provides information regarding the underlying algorithm, but also provides data about the type of information located in the data store 410 that was used by the algorithm. In particular, the robustness/amount of variables located in the data set that was processed may be identified. In particular, the variables that are found in greater numbers generates a smooth line/surface/multidimensional space with minimal inflections. The data points with minimal data points generates regions of high variability and high inflection points.

In order to address these insights into the algorithm performance, and the nature of the data that was used in the analysis by the algorithm, a series of protections are put into place. Firstly, the function undergoes a “smoothing” process. This process identifies regions of the performance model 401 which are highly variable (thus indicating a low number of instances of the attribute in the underlying data store 410), and ‘smooths’ out these regions. This smoothing process may include performing a best fit transform, moving averages and application of filters, Loess smoothing, kernel smoothing, wavelets, splines or some combination thereof. The choice of kernel or smoothing function is driven by the need to obfuscate the locations of the specific data points used to construct the performance model 401. In practice, this can be achieved by requiring a minimum number of data points to be included within each sample, or by requiring a maximum curvature of the regression surface, or by requiring explicit boundary conditions between sampling regions, as in fitting a spline or other smoothed interpolation to the surface. To avoid overestimation of performance in regions “outside” the sample volume, it is possible to apply a regularization that drives the value of the performance model 401 to zero outside well-sampled regions. For active learning applications, this ensures that new data points are likely to be selected for additional labeling. By smoothing out the performance model 401, the underlying dataset that was processed by the algorithm is protected from making inferences about.

The other manner in which the performance model 401 is protected to prevent the wrong parties from discovering information regarding the underlying algorithm is to encrypt the performance model within the sequestered computing node 110. This encryption may only be decrypted by the algorithm developer 120, thus preventing the data steward 160 and the core management system 140 from accessing the performance model 401 as it is routed from the sequestered computing node 110 to the algorithm developer 120.

Once the algorithm developer 120 receives the performance model 401 it may be decrypted, and leveraged to validate the algorithm and, importantly, may be leveraged to actively train the algorithm in the future. This may occur by identifying regions of the performance model 401 that have lower performance ratings and identify attributes/variables in the datasets that correspond to these poorer performing model segments. The system then incorporates human feedback when such variables are present in a dataset to assist in generating a gold standard training set for these variable combinations. The performance model may then be trained based upon these gold standard training sets. Even without the generation of additional gold standard data, investigation of poorer performing model segments enables changes to the functional form of the model and testing for better performance. It is likewise possible that the inclusion of additional variables by the model allows for the distinction of attributes of a patient population. This is identified by areas of the model that has a lower performance which indicates that there is a fundamental issue with the model. An example is that a model operates well (has higher performance) for male patients as compared to female patients. This may indicate that different model mechanics may be required for female patient populations.

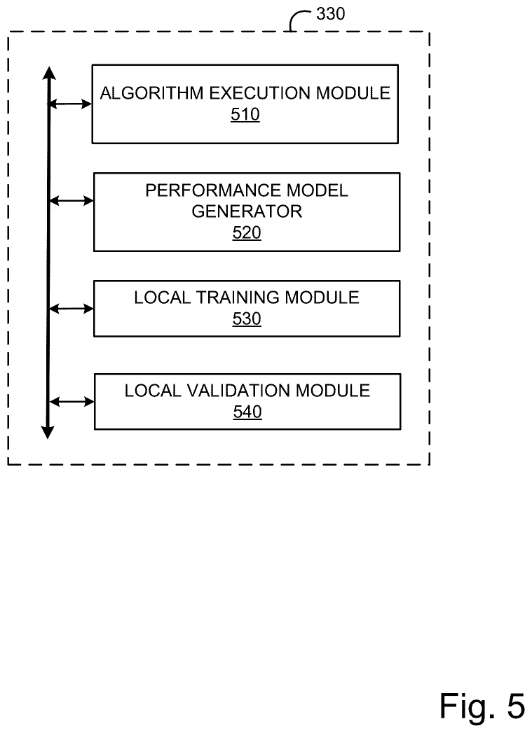

FIG. 5 provides a more detailed illustration of the functional components of the runtime server 330. An algorithm execution module 510 performs the actual processing of the PHI 411 using the algorithm 325. The result of this execution includes the generation of discrete inferences.

The runtime server 330 includes the performance model generator 520 which receives outputs from the algorithm execution module 510 and generates the performance model 401 using a recursion methodology as outlined above.

In some embodiments, the runtime server 330 may additionally execute a master algorithm, and tune the algorithm locally at a local training module 530. Such localized training is known, however, in the present system, the local training module 530 is configured to take the locally tuned model and then reoptimize the master. The new reoptimized master may, in a reliable manner, be retuned to achieve performance that is better than the prior model's performance, yet staying consistent with the prior model. This consistency includes relative weighting of particular datapoints to ensure consistency in the models for these key elements while at the same time improving performance of the model generally.

In some embodiments, the confirmation that a retuned model is performing better than the prior version is determined by a local validation module 540. The local validation module 540 may include a mechanical test whereby the algorithm is deployed with a model specific validation methodology that is capable of determining that the algorithm performance has not deteriorated after a re-optimization. In some embodiments, the tuning may be performed on different data splits, and these splits are used to define a redeployment method. It should be noted that increasing the number (N) of samplings used for optimization not only improves the model's performance, but also reduces the size of the confidence interval.

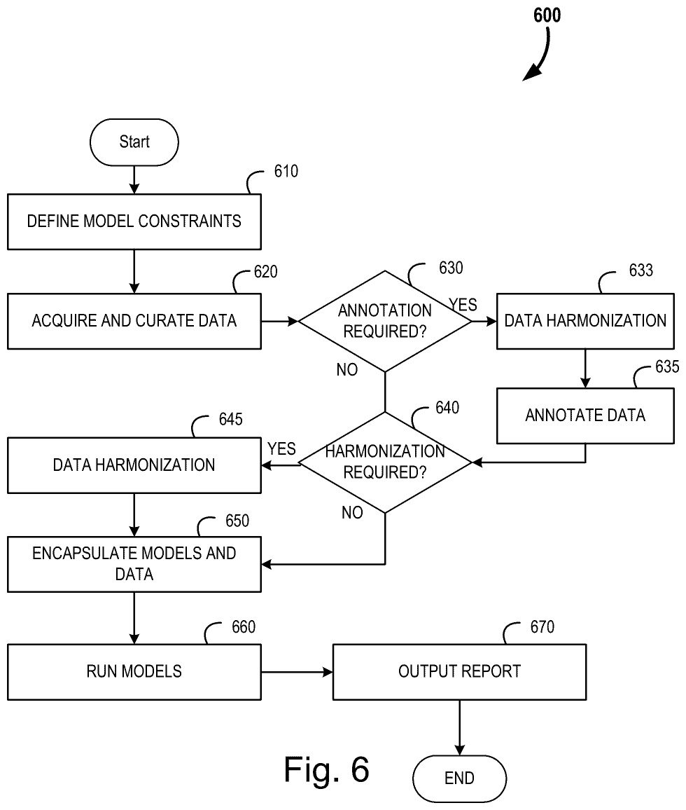

Turning to FIG. 6, one embodiment of the process for deployment and running of algorithms within the sequestered computing nodes is illustrated, at 600. Initially the algorithm developer provides the algorithm to the system. The at least one algorithm/model is generated by the algorithm developer using their own development environment, tools, and seed data sets (e.g., training/testing data sets). In some embodiments, the algorithms may be trained on external datasets instead, as will be discussed further below. The algorithm developer provides constraints (at 610) for the optimization and/or validation of the algorithm(s). Constraints may include any of the following: (i) training constraints, (ii) data preparation constraints, and (iii) validation constraints. These constraints define objectives for the optimization and/or validation of the algorithm(s) including data preparation (e.g., data curation, data transformation, data harmonization, and data annotation), model training, model validation, and reporting.

In some embodiments, the training constraints may include, but are not limited to, at least one of the following: hyperparameters, regularization criteria, convergence criteria, algorithm termination criteria, training/validation/test data splits defined for use in algorithm(s), and training/testing report requirements. A model hyper parameter is a configuration that is external to the model, and which value cannot be estimated from data. The hyperparameters are settings that may be tuned or optimized to control the behavior of a ML or AI algorithm and help estimate or learn model parameters.

Regularization constrains the coefficient estimates towards zero. This discourages the learning of a more complex model in order to avoid the risk of overfitting. Regularization, significantly reduces the variance of the model, without a substantial increase in its bias. The convergence criterion is used to verify the convergence of a sequence (e.g., the convergence of one or more weights after a number of iterations). The algorithm termination criteria define parameters to determine whether a model has achieved sufficient training. Because algorithm training is an iterative optimization process, the training algorithm may perform the following steps multiple times. In general, termination criteria may include performance objectives for the algorithm, typically defined as a minimum amount of performance improvement per iteration or set of iterations.

The training/testing report may include criteria that the algorithm developer has an interest in observing from the training, optimization, and/or testing of the one or more models. In some instances, the constraints for the metrics and criteria are selected to illustrate the performance of the models. For example, the metrics and criteria such as mean percentage error may provide information on bias, variance, and other errors that may occur when finalizing a model such as vanishing or exploding gradients. Bias is an error in the learning algorithm. When there is high bias, the learning algorithm is unable to learn relevant details in the data. Variance is an error in the learning algorithm, when the learning algorithm tries to over-learn from the dataset or tries to fit the training data as closely as possible. Further, common error metrics such as mean percentage error and R2 score are not always indicative of accuracy of a model, and thus the algorithm developer may want to define additional metrics and criteria for a more in depth look at accuracy of the model.

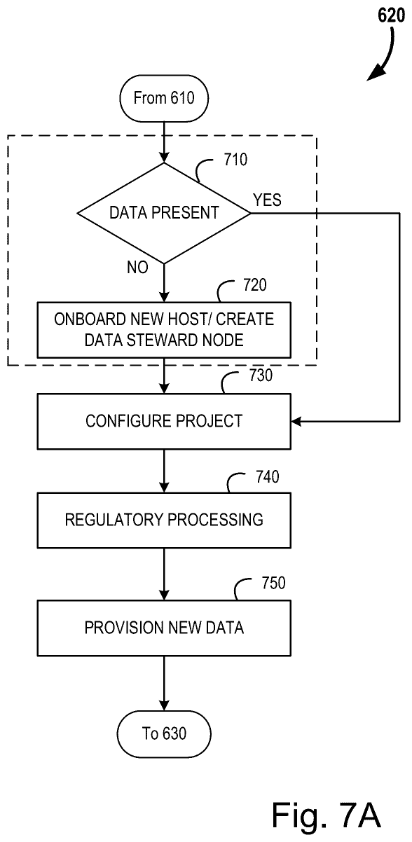

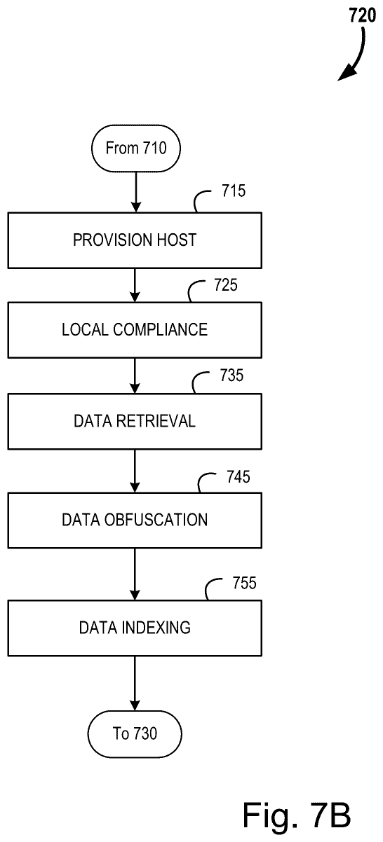

Next, data assets that will be subjected to the algorithm(s) are identified, acquired, and curated (at 620). FIG. 7A provides greater detail of this acquisition and curation of the data. Often, the data may include healthcare related data (PHI). Initially, there is a query if data is present (at 710). The identification process may be performed automatically by the platform running the queries for data assets (e.g., running queries on the provisioned data stores using the data indices) using the input data requirements as the search terms and/or filters. Alternatively, this process may be performed using an interactive process, for example, the algorithm developer may provide search terms and/or filters to the platform. The platform may formulate questions to obtain additional information, the algorithm developer may provide the additional information, and the platform may run queries for the data assets (e.g., running queries on databases of the one or more data hosts or web crawling to identify data hosts that may have data assets) using the search terms, filters, and/or additional information. In either instance, the identifying is performed using differential privacy for sharing information within the data assets by describing patterns of groups within the data assets while withholding private information about individuals in the data assets.

If the assets are not available, the process generates a new data steward node (at 720). The data query and onboarding activity (surrounded by a dotted line) is illustrated in this process flow of acquiring the data; however, it should be realized that these steps may be performed any time prior to model and data encapsulation (step 650 in FIG. 6). Onboarding/creation of a new data steward node is shown in greater detail in relation to FIG. 7B. In this example process a data host compute and storage infrastructure (e.g., a sequestered computing node as described with respect to FIGS. 1A-5) is provisioned (at 715) within the infrastructure of the data steward. In some instances, the provisioning includes deployment of encapsulated algorithms in the infrastructure, deployment of a physical computing device with appropriately provisioned hardware and software in the infrastructure, deployment of storage (physical data stores or cloud-based storage), or deployment on public or private cloud infrastructure accessible via the infrastructure, etc.

Next, governance and compliance requirements are performed (at 725). In some instances, the governance and compliance requirements includes getting clearance from an institutional review board, and/or review and approval of compliance of any project being performed by the platform and/or the platform itself under governing law such as the Health Insurance Portability and Accountability Act (HIPAA). Subsequently, the data assets that the data steward desires to be made available for optimization and/or validation of algorithm(s) are retrieved (at 735). In some instances, the data assets may be transferred from existing storage locations and formats to provisioned storage (physical data stores or cloud-based storage) for use by the sequestered computing node (curated into one or more data stores). The data assets may then be obfuscated (at 745). Data obfuscation is a process that includes data encryption or tokenization, as discussed in much greater detail below. Lastly, the data assets may be indexed (at 755). Data indexing allows queries to retrieve data from a database in an efficient manner. The indexes may be related to specific tables and may be comprised of one or more keys or values to be looked up in the index (e.g., the keys may be based on a data table's columns or rows).

Returning to FIG. 7A, after the creation of the new data steward, the project may be configured (at 730). In some instances, the data steward computer and storage infrastructure is configured to handle a new project with the identified data assets. In some instances, the configuration is performed similarly to the process described of FIG. 7B. Next, regulatory approvals (e.g., IRB and other data governance processes) are completed and documented (at 740). Lastly, the new data is provisioned (at 750). In some instances, the data storage provisioning includes identification and provisioning of a new logical data storage location, along with creation of an appropriate data storage and query structure.

Returning now to FIG. 6, after the data is acquired and configured, a query is performed if there is a need for data annotation (at 630). If so, the data is initially harmonized (at 633) and then annotated (at 635). Data harmonization is the process of collecting data sets of differing file formats, naming conventions, and columns, and transforming it into a cohesive data set. The annotation is performed by the data steward in the sequestered computing node. A key principle to the transformation and annotation processes is that the platform facilitates a variety of processes to apply and refine data cleaning and transformation algorithms, while preserving the privacy of the data assets, all without requiring data to be moved outside of the technical purview of the data steward.

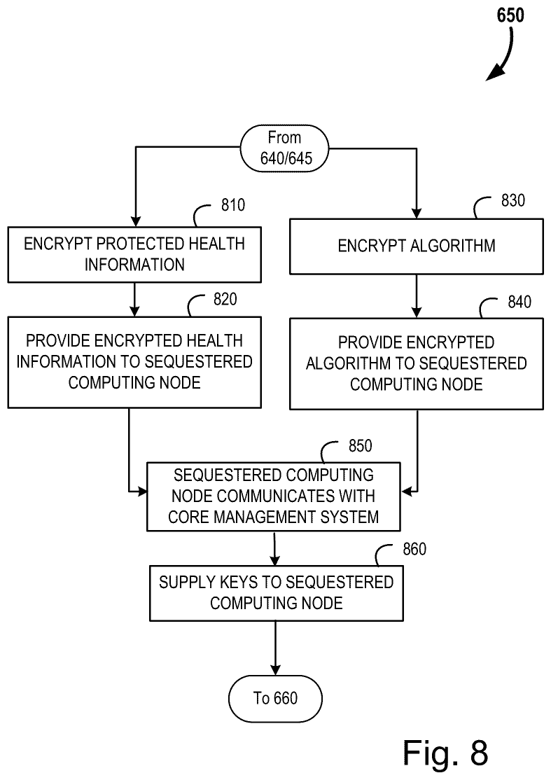

After annotation, or if annotation was not required, another query determines if additional data harmonization is needed (at 640). If so, then there is another harmonization step (at 645) that occurs in a manner similar to that disclosed above. After harmonization, or if harmonization isn't needed, the models and data are encapsulated (at 650). Data and model encapsulation is described in greater detail in relation to FIG. 8. In the encapsulation process the protected data, and the algorithm are each encrypted (at 810 and 830 respectively). In some embodiments, the data is encrypted either using traditional encryption algorithms (e.g., RSA) or homomorphic encryption.

Next the encrypted data and encrypted algorithm are provided to the sequestered computing node (at 820 and 840 respectively). There processes of encryption and providing the encrypted payloads to the sequestered computing nodes may be performed asynchronously, or in parallel. Subsequently, the sequestered computing node may phone home to the core management node (at 850) requesting the keys needed. These keys are then also supplied to the sequestered computing node (at 860), thereby allowing the decryption of the assets.

Returning again to FIG. 6, once the assets are all within the sequestered computing node, they may be decrypted and the algorithm may run against the dataset (at 660). The results from such runtime may be outputted as a report (at 670) for downstream consumption.

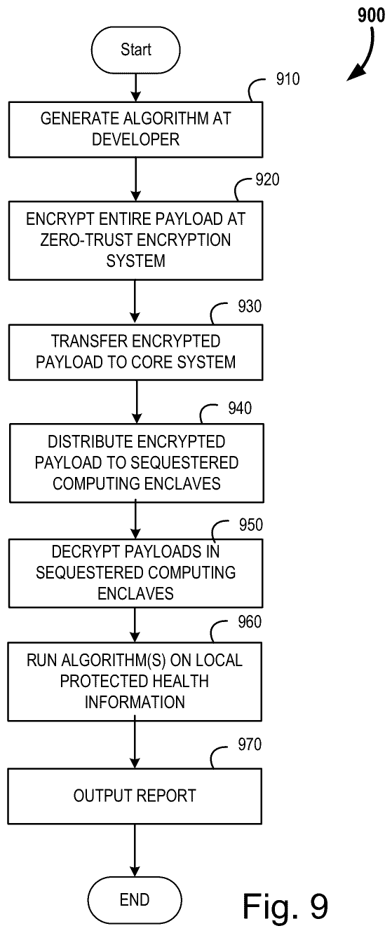

Turning now to FIG. 9, a first embodiment of the system for zero-trust processing of the data assets by the algorithm is provided, at 900. In this example process, the algorithm is initially generated by the algorithm developer (at 910) in a manner similar to that described previously. The entire algorithm, including its container, is then encrypted (at 920), using a public key, by the encryption server within the zero-trust system of the algorithm developer's infrastructure. The entire encrypted payload is provided to the core management system (at 930). The core management system then distributes the encrypted payload to the sequestered computing enclaves (at 940).

Likewise, the data steward collects the data assets desired for processing by the algorithm. This data is also provided to the sequestered computing node. In some embodiments, this data may also be encrypted. The sequestered computing node then contacts the core management system for the keys. The system relies upon public-private key methodologies for the decryption of the algorithm, and possibly the data (at 950).

After decryption within the sequestered computing node, the algorithm(s) are run (at 960) against the protected health information (or other sensitive information based upon the given use case). The results are then output (at 970) to the appropriate downstream audience (generally the data steward, but may include public health agencies or other interested parties).

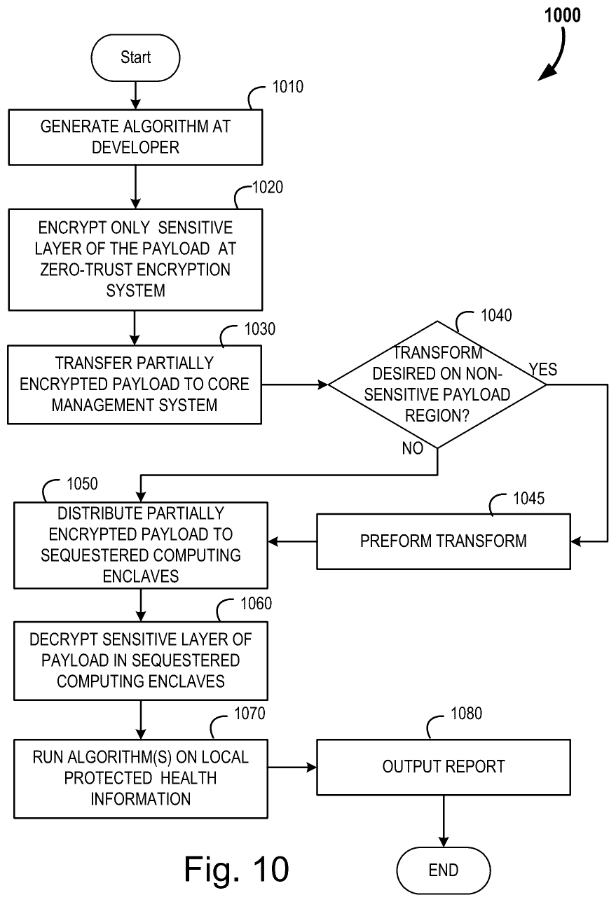

FIG. 10, on the other hand, provides another methodology of zero-trust computation that has the advantage of allowing some transformation of the algorithm data by either the core management system or the data steward themselves, shown generally at 1000. As with the prior embodiment, the algorithm is initially generated by the algorithm developer (at 1010). However, at this point the two methodologies diverge. Rather than encrypt the entire algorithm payload, it differentiates between the sensitive portions of the algorithm (generally the algorithm weights), and non-sensitive portions of the algorithm (including the container, for example). The process then encrypts only layers of the payload that have been flagged as sensitive (at 1020).

The partially encrypted payload is then transferred to the core management system (at 1030). At this stage a determination is made whether a modification is desired to the non-sensitive, non-encrypted portion of the payload (at 1040). If a modification is desired, then it may be performed in a similar manner as discussed previously (at 1045).

If no modification is desired, or after the modification is performed, the payload may be transferred (at 1050) to the sequestered computing node located within the data steward infrastructure (or a third party). Although not illustrated, there is again an opportunity at this stage to modify any non-encrypted portions of the payload when the algorithm payload is in the data steward's possession.

Next, the keys unique to the sequestered computing node are employed to decrypt the sensitive layer of the payload (at 1060), and the algorithms are run against the locally available protected health information (at 1070). In the use case where a third party is hosting the sequestered computing node, the protected health information may be encrypted at the data steward before being transferred to the sequestered computing node at said third party. Regardless of sequestered computing node location, after runtime, the resulting report is outputted to the data steward and/or other interested party (at 1080).

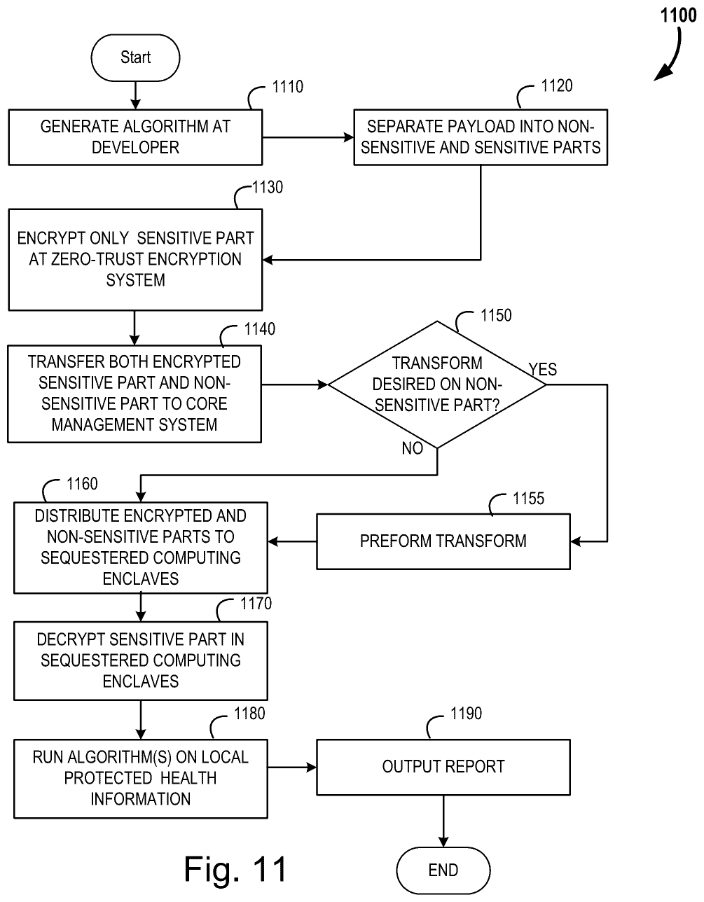

FIG. 11, as seen at 1100, is similar to the prior two figures in many regards. The algorithm is similarly generated at the algorithm developer (at 1110); however, rather than being subject to an encryption step immediately, the algorithm payload may be logically separated into a sensitive portion and a non-sensitive portion (at 1120). To ensure that the algorithm runs properly when it is ultimately decrypted in the (sequestered) sequestered computing enclave, instructions about the order in which computation steps are carried out may be added to the unencrypted portion of the payload.

Subsequently, the sensitive portion is encrypted at the zero-trust encryption system (at 1130), leaving the non-sensitive portion in the clear. Both the encrypted portion and the non-encrypted portion of the payload are transferred to the core management system (at 1140). This transfer may be performed as a single payload, or may be done asynchronously. Again, there is an opportunity at the core management system to perform a modification of the non-sensitive portion of the payload. A query is made if such a modification is desired (at 1150), and if so it is performed (at 1155). Transformations may be similar to those detailed above.

Subsequently, the payload is provided to the sequestered computing node(s) by the core management system (at 1160). Again, as the payload enters the data steward node(s), it is possible to perform modifications to the non-encrypted portion(s). Once in the sequestered computing node, the sensitive portion is decrypted (at 1170), the entire algorithm payload is run (at 1180) against the data that has been provided to the sequestered computing node (either locally or supplied as an encrypted data package). Lastly, the resulting report is outputted to the relevant entities (at 1190).

Any of the above modalities of operation provide the instant zero-trust architecture with the ability to process a data source with an algorithm without the ability for the algorithm developer to have access to the data being processed, the data steward being unable to view the algorithm being used, or the core management system from having access to either the data or the algorithm. This uniquely provides each party the peace of mind that their respective valuable assets are not at risk, and facilitates the ability to easily, and securely, process datasets.

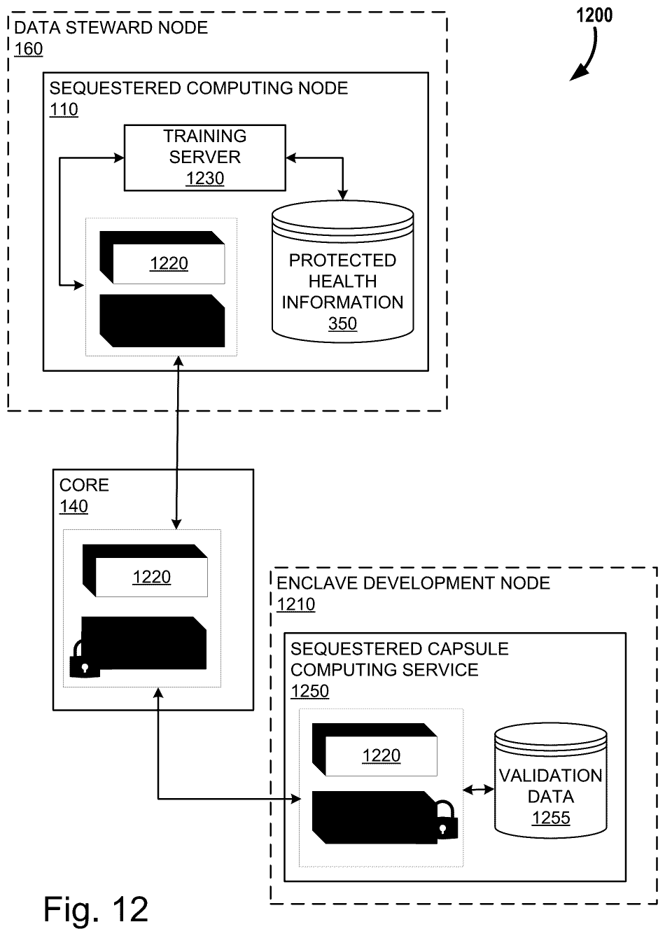

Turning now to FIG. 12, a system for zero-trust training of algorithms is presented, generally at 1200. Traditionally, algorithm developers require training data to develop and refine their algorithms. Such data is generally not readily available to the algorithm developer due to the nature of how such data is collected, and due to regulatory hurdles. As such, the algorithm developers often need to rely upon other parties (data stewards) to train their algorithms. As with running an algorithm, training the algorithm introduces the potential to expose the algorithm and/or the datasets being used to train it.

In this example system, the nascent algorithm is provided to the sequestered computing node 110 in the data steward node 160. This new, untrained algorithm may be prepared by the algorithm developer (not shown) and provided in the clear to the sequestered computing node 110 as it does not yet contain any sensitive data. The sequestered computing node leverages the locally available protected health information 350, using a training server 1230, to train the algorithm. This generates a sensitive portion of the algorithm 1225 (generally the weights and coefficients of the algorithm), and a non-sensitive portion of the algorithm 1220. As the training is performed within the sequestered computing node 110, the data steward 160 does not have access to the algorithm that is being trained. Once the algorithm is trained, the sensitive portion 1225 of the algorithm is encrypted prior to being released from the sequestered computing enclave 110. This partially encrypted payload is then transferred to the data management core 140, and distributed to a sequestered capsule computing service 1250, operating within an enclave development node 1210. The enclave development node is generally hosted by one or more data stewards.

The sequestered capsule computing node 1250 operates in a similar manner as the sequestered computing node 110 in that once it is “locked” there is no visibility into the inner workings of the sequestered capsule computing node 1250. As such, once the algorithm payload is received, the sequestered capsule computing node 1250 may decrypt the sensitive portion of the algorithm 1225 using a public-private key methodology. The sequestered capsule computing node 1250 also has access to validation data 1255. The algorithm is run against the validation data, and the output is compared against a set of expected results. If the results substantially match, it indicates that the algorithm is properly trained, if the results do not match, then additional training may be required.

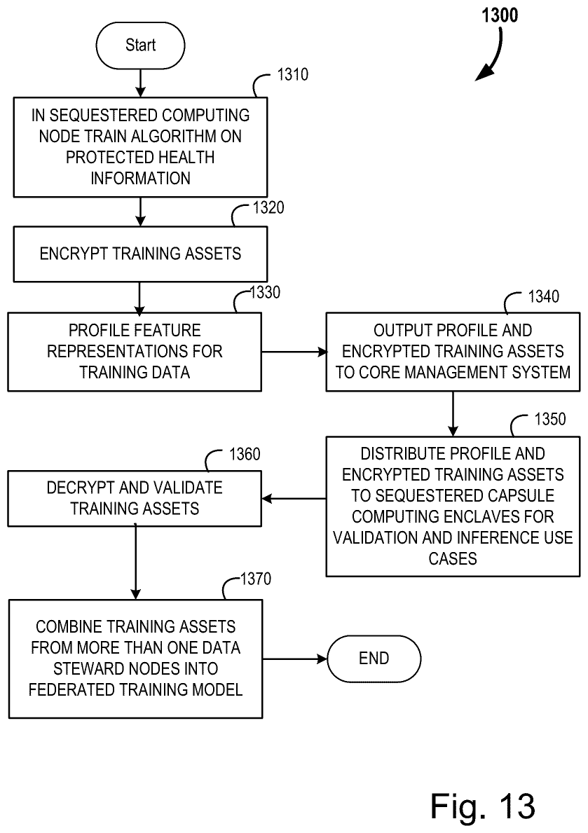

FIG. 13 provides the process flow, at 1300, for this training methodology. In the sequestered computing node, the algorithm is initially trained (at 1310). The training assets (sensitive portions of the algorithm) are encrypted within the sequestered computing node (at 1320). Subsequently the feature representations for the training data are profiled (at 1330). One example of a profiling methodology would be to take the activations of the certain AI model layers for samples in both the training and test set, and see if another model can be trained to recognize which activations came from which dataset. These feature representations are non-sensitive, and are thus not encrypted. The profile and the encrypted data assets are then output to the core management system (at 1340) and are distributed to one or more sequestered capsule computing enclaves (at 1350). At the sequestered capsule computing node, the training assets are decrypted and validated (at 1360). After validation the training assets from more than one data steward node are combined into a single featured training model (at 1370). This is known as federated training.

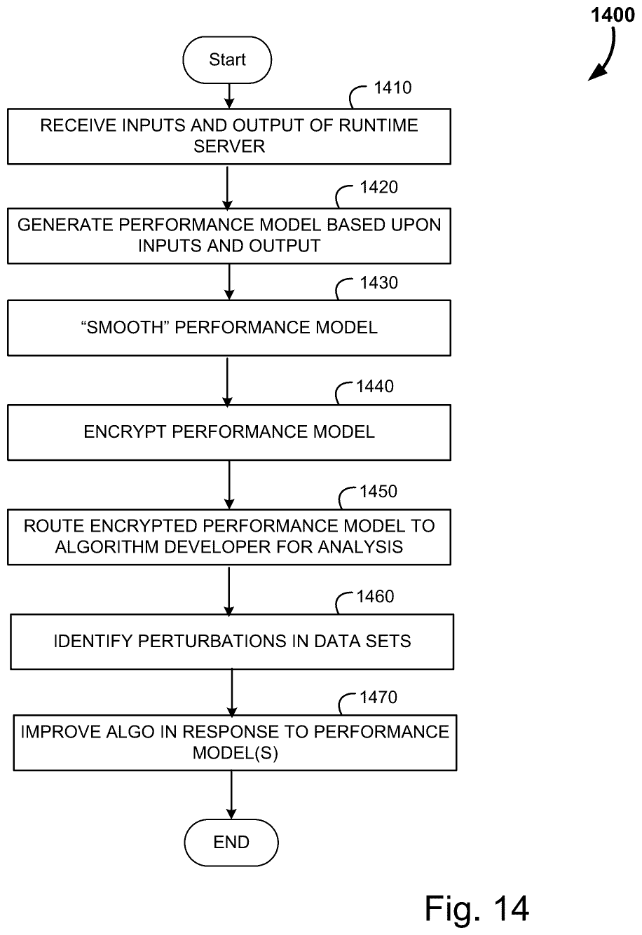

Turning now to FIG. 14 which provides a flowchart for an example process 1400 of generating and utilizing a performance model 401 in a zero-trust environment. In this example process, the runtime server receives inputs of the underlying algorithm and the sensitive information that is to be processed. This all occurs in the sequestered computing node, and as such is inaccessible by any party. The runtime server processes the sensitive information using the algorithm and generates a set of outputs (at 1410). The output of the processing by the algorithm is used to generate the performance model (at 1420).

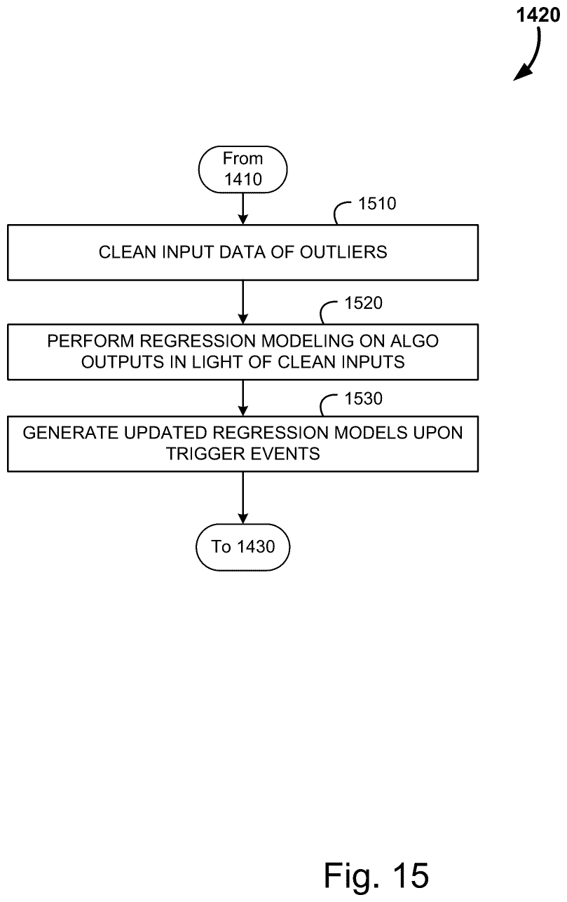

FIG. 15 provides more detail into the process of generating the performance model. This process includes cleaning the input data of any outliers (at 1510). Determination of which inputs are “outliers” may be based upon values that are outside of possible ranges (e.g., a body temperature of 45° C.), or may be based upon a degree of difference from the mean value (e.g., one standard deviation). Next the regression model may be generated based upon the algorithm outputs from the cleaned input data (at 1520).

The generation of the regression model is not a static thing. Rather, the performance model may be updated over time or according to some other triggering event (at 1530). Such a triggering event may include an update or iteration of the underlying algorithm (one or N times), after some configurable number of times the algorithm processes new data, or the like. Updating the performance model ensures that the model does not get stale as the underlying algorithm evolves, and further increases the accuracy of the performance model in light of the increased operations of the underlying algorithm.

Returning to FIG. 14, after the performance model is generated (or updated), a “smoothing” operation may occur for regions of the performance model that indicate instability (e.g., frequent inflections). This smoothing may include applying any of the methods previously discussed. Smoothing of the unstable regions of the performance model tends to provide a more accurate representation of the underlying algorithm's performance in these regions (set of input variables). More importantly, however, such smoothing eliminates the possibility that the algorithm developer (the final recipient of the performance model) can deduce anything regarding the underlying data that the algorithm operated upon. This is because such variable regions of the performance model tend to correlate with a lack of data points in the input data. For example, if the underlying dataset has very few African American patients, the performance of the model, as relates to the variable of race, and particularly African American patients, may exhibit a higher degree of variability in the algorithm's performance.

In some particular embodiments, the smoothing operation may apply to any region of the performance model that exhibits a large degree of variability. In other embodiments, the system may compare the regions of high variability to total sample numbers. For regions of variability where there are few underlying datapoints, the smoothing operation may be applied (which is typically all, or most, of the instances of high variability). However, in some cases, it is possible that the performance model may exhibit “true” variability. This is the case when there is actually a statistically significant number of underlying data points, but for whatever reason, the algorithm's performance for these sets of variables is highly selective to specific variable combinations and/or small changes in the variables (e.g., accurate for 40 year old's, but inaccurate for 37 year old's, and then accurate again for 35 year old's). In these cases, the fact that the algorithm's performance is so variable may be important for the algorithm developer to have knowledge of, and as such no smoothing operation would be applied to such regions.

For reference, the term statistically significant, as used in this and the above paragraph, may be a configurable number of samples (e.g., 100 data points), or may be a number of data points that generates a confidence interval of a set percentage (e.g., 95% confident). It should be noted that there is a small downside to not smoothing these regions: the algorithm developer is made aware that this region of the input variables includes a statistically significant number of underlying samples (e.g., for the present example, the algorithm developer would know there are a large number of samples for patients in the age range of 35-40 years old). However, as these situations of “true” variability in performance are relatively rare, and the algorithm developer is provided no other information regarding numbers of underlying data points, this presentation of some regions that are not smoothed may be an acceptable tradeoff.

All this smoothing activity takes place in the sequestered computing node 110, and as such the data steward does not have access to the performance model (which would allow the data steward to make inferences regarding the algorithm), nor is it made available to the core management system (which would allow for inference generation regarding the underlying patient data and the algorithm). The smoothed performance model is then encrypted (at 1440) within the sequestered computing node 110, so that during transfer to the algorithm developer is remains inaccessible to the data steward, the core management system, and any other possible third parties that may intercept the package in transit. Again, this is critical because the performance model provides significant information regarding the underlying algorithm's operations, inputs, and possibly inferences that are generated by the algorithms. This would significantly increase a third party's ability to reverse engineer the algorithm; hence the importance of ensuring that nobody can access the performance model besides the sequestered computing node 110 and the algorithm developer (or in some cases another trusted designated party, such as a regulatory body). As noted, the routing of the encrypted performance model package may be facilitated through the core management system on its way to the core management system (at 1450).

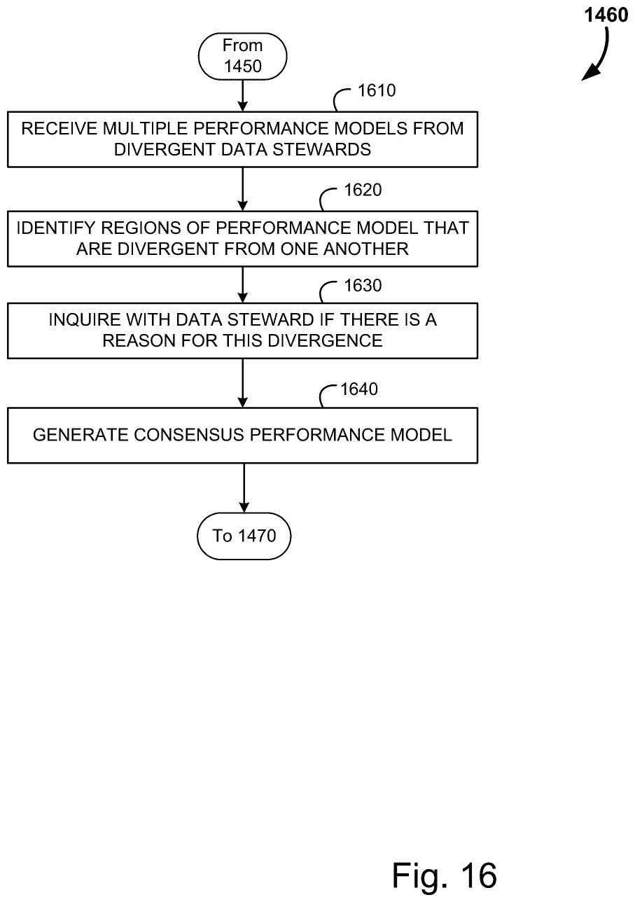

Once the algorithm developer has received the package, it is decrypted (not shown), and analyzed by the algorithm developer to gain insights into the functioning of their deployed algorithm. One analysis performed is the identification of perturbations within the data set (at 1460). FIG. 16 provides a more detailed explanation of the process for identifying data set perturbations. The process for identifying data set perturbations requires the algorithm developer to receive performance models from a number of different data stewards (preferably three or more) for the same algorithm operating on their individual and unique data sets (at 1610). In general, there will invariable be some differences in performance given that the data sets being analyzed are not identical, however, in general, the performance models should track one another relatively closely. When there are regions of a particular performance model that are divergent from others (or the entire model is divergent), this strongly indicative of something “wrong” with the underlying data. For example, a column that has been improperly transposed (swapping systolic and diastolic blood pressure for example), would cause a significant perturbation in the algorithm's performance for these inputs. As such, the algorithm developer may identify these regions that “standout” as being divergent from the other performance models (at 1620). This allows the algorithm developer to inquire with the data steward for an explanation for said divergence (at 1630). This allows for one of three things: 1) either the data steward identifies an error in their data, 2) the data steward may indicate that there is a special condition associated with the patients associated with the variables implicated by the divergence, or 3) the data steward may be alerted to something that warrants further investigation (for example, maybe their patients between 60 and 80 years old were in a region where there is more pollution present and therefore are more prone to asthma as compared against a general cross section of the population). Regardless of outcome, the identification of such perturbations generally increases fidelity of the underlying data set or provides greater insights into the patient population and/or how the algorithm treats different patient types.

Once the perturbations are resolved, the algorithm developer may generate a consensus performance model by merging the various models (at 1640). This consensus model generally omits unusual perturbances in any given model. This consensus model may be leveraged for other downstream analysis of the algorithm.

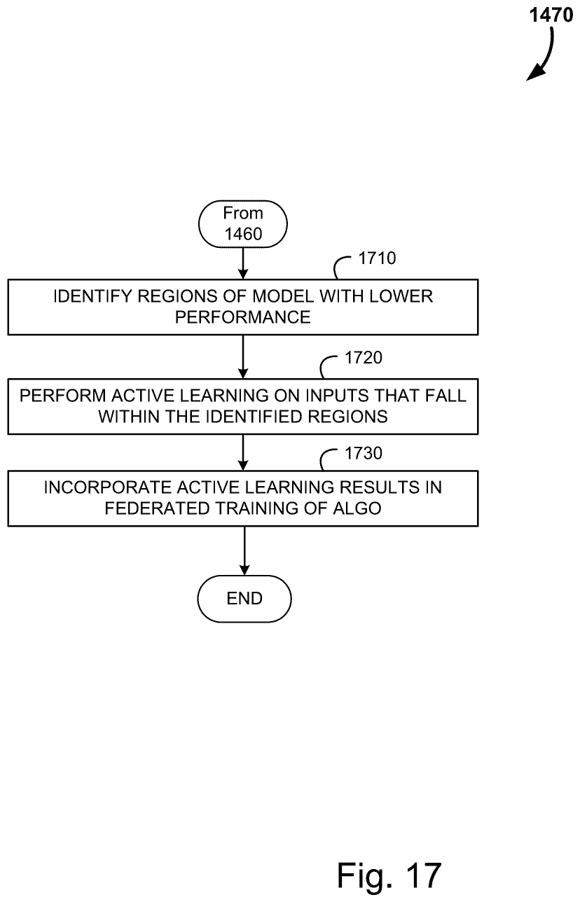

Returning to FIG. 14, after the identification and handling of performance model perturbances is complete, the algorithm developer may leverage the performance model (or the consensus model when available) to improve the algorithm through active learning techniques (at 1470). FIG. 17 provides further detail regarding the improvement of the algorithm in response to the performance model. Initially the regions of the performance model with a lower level of performance (variables that the algorithm has lower accuracy making inferences about) are identified (at 1710). Next, the algorithm developer provides feedback to the data steward to do active learning on the variables that the algorithm is struggling with (at 1720). This differs from traditional active learning techniques in that traditional active learning takes samples along the boundary of the confidence threshold for the model and trains upon gold standard inputs for these variable sets. The present system rather identifies variable clusters that are generally lower performance (even if the confidence interval is high/not near a decision boundary) and trains based upon these variable clusters. This may fundamentally alter the model functioning rather than merely refine the confidences of borderline instances of classifications.

In response to this feedback from the algorithm developer, the data steward will, when analyzing data with the identified variables, include a human in the loop. The human will identify the inference, and this inference will be labeled as a gold standard for purposes of training the model. The model may then be locally trained (as discussed previously), and results of the training may be provided back to the algorithm developer in order to perform federated training on the algorithm (at 1730). This concludes the process of performance model generation and utilization by the algorithm developer.

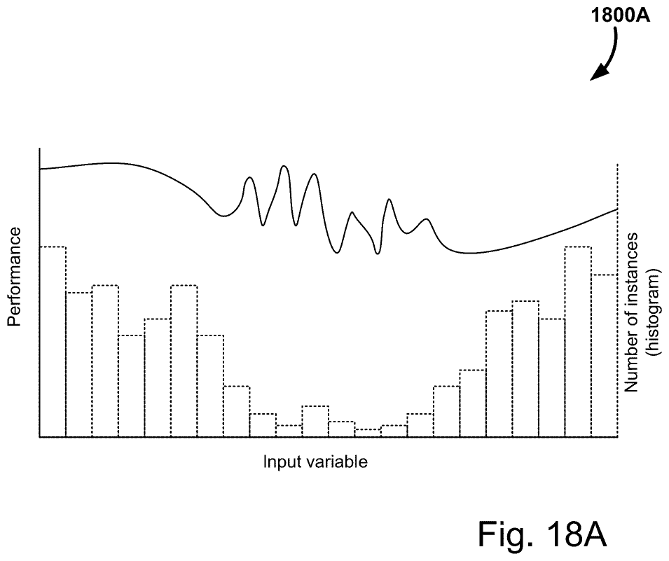

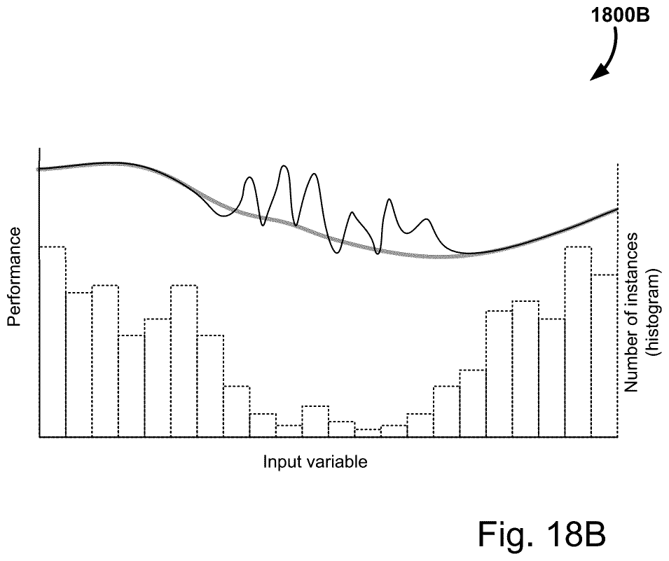

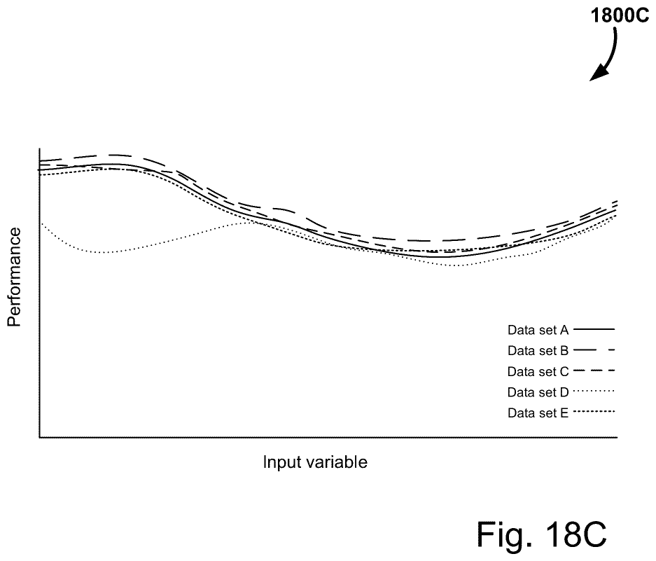

FIGS. 18A-C provide example graph diagrams of an example performance model of an example algorithm. For the sake of clarity, this algorithm has been greatly simplified to include a single input variable. As noted previously, an algorithm with two input variables would result in a performance model that would resemble a surface, while algorithms that consume many variables would be an abstraction that is incomprehensible to a human but may be modeled by computer systems. Generally, most algorithms consume a large number (at least greater than 3) of input variables, so the examples provided herein are crude representations of actual performance modeling. Again, for the sake of clarity and understanding, a simplified algorithm is provided for this example.

In FIG. 18A, a raw performance model is presented, shown generally at 1800A. This model includes the performance (as a solid line) over the gradations of a single input variable. Additionally, the instances of the given input variable are provided as a histogram (in dotted lines). It should be noted that the performance model provides a smooth line when sufficient numbers of a given variable are present, but the graph becomes “choppy”/highly variable and with a number of inflections when the number of input variables is lower than a particular threshold. This variability is due to the fact that the algorithm has such little data to work off of, the performance may swing wildly as compared to a set of gold standards. These performance values are generally inaccurate as a result as well.

FIG. 18B provides the same example graph, except in this instance the performance model has been smoothed, shown generally at 1800B. The smoothed performance model (illustrated as the thicker grey line) is a best fit curve given the raw performance curve. The best fit may numerically weight the value of the data points that it is fitting to based upon the number of instances of the variable, in some embodiments. As such, the curve may more tightly follow the raw curve for regions that have high instances of the variable (either end of the graph) and adhere to the graph more loosely when the instances of the variables are less (the center of the graph). As noted previously, by smoothing out the curve (or surface, space, or multidimensional abstraction), the algorithm developer who receives the smooth curve cannot make inferences regarding the underlying patient population.

FIG. 18C provides an example situation where numerous performance models have been received and plotted together on the same graph, shown generally at 1800 C. Generally, the performance models track one another well; however, in one of the models (shown in the finest dotted line) there is a significant perturbation of the performance at the beginning of the graph. For example, it the graph input variable included individuals between the age of 20-60, this perturbation would signify that the data from this particular data set differs in some manner for individuals between the ages of 20-35. This perturbation may be due to a mistake in the data, or may be due to some actual difference in the patient population (which may have diagnostic relevance in and of itself). It is possible for example, that for this dataset, the patients who are 20-35 just happen to include a larger percentage of smokers as compared to the other datasets. This provides two pieces of information: 1) it allows the data steward to know that their population may be unusual and should be treated differently (e.g., screened for lung cancer on a routine basis), and 2) it informs the algorithm developer that for this other metric (here smoking) the algorithm performance suffers significantly. Other causes of such perturbations may include data errors. As such, perturbation in a particular performance model may be leveraged to increase data fidelity.

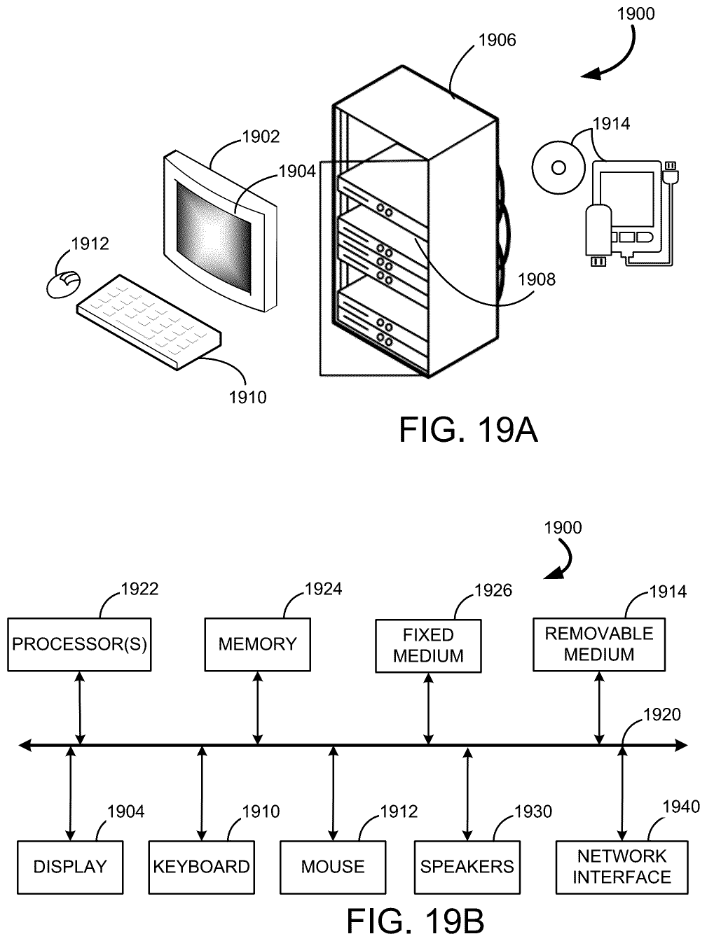

Now that the systems and methods for zero-trust computing have been provided, attention shall now be focused upon apparatuses capable of executing the above functions in real-time. To facilitate this discussion, FIGS. 19A and 19B illustrate a Computer System 1900, which is suitable for implementing embodiments of the present invention. FIG. 19A shows one possible physical form of the Computer System 1900. Of course, the Computer System 1900 may have many physical forms ranging from a printed circuit board, an integrated circuit, and a small handheld device up to a huge supercomputer. Computer system 1900 may include a Monitor 1902, a Display 1904, a Housing 1906, server blades including one or more storage Drives 1908, a Keyboard 1910, and a Mouse 1912. Medium 1914 is a computer-readable medium used to transfer data to and from Computer System 1900.

FIG. 19B is an example of a block diagram for Computer System 1900. Attached to System Bus 1920 are a wide variety of subsystems. Processor(s) 1922 (also referred to as central processing units, or CPUs) are coupled to storage devices, including Memory 1924. Memory 1924 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable form of the computer-readable media described below. A Fixed Medium 1926 may also be coupled bi-directionally to the Processor 1922; it provides additional data storage capacity and may also include any of the computer-readable media described below. Fixed Medium 1926 may be used to store programs, data, and the like and is typically a secondary storage medium (such as a hard disk) that is slower than primary storage. It will be appreciated that the information retained within Fixed Medium 1926 may, in appropriate cases, be incorporated in standard fashion as virtual memory in Memory 1924. Removable Medium 1914 may take the form of any of the computer-readable media described below.

Processor 1922 is also coupled to a variety of input/output devices, such as Display 1904, Keyboard 1910, Mouse 1912 and Speakers 1930. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 1922 optionally may be coupled to another computer or telecommunications network using Network Interface 1940. With such a Network Interface 1940, it is contemplated that the Processor 1922 might receive information from the network, or might output information to the network in the course of performing the above-described zero-trust processing of protected information, for example PHI. Furthermore, method embodiments of the present invention may execute solely upon Processor 1922 or may execute over a network such as the Internet in conjunction with a remote CPU that shares a portion of the processing.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this disclosure. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

In operation, the computer system 1900 can be controlled by operating system software that includes a file management system, such as a medium operating system. One example of operating system software with associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The algorithms and displays presented herein are not inherently related to any particular computer or other apparatus. Various general-purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may, thus, be implemented using a variety of programming languages.

In alternative embodiments, the machine operates as a standalone device or may be connected (e.g., networked) to other machines. In a networked deployment, the machine may operate in the capacity of a server or a client machine in a client-server network environment or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, Glasses with a processor, Headphones with a processor, Virtual Reality devices, a processor, distributed processors working together, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer (or distributed across computers), and when read and executed by one or more processing units or processors in a computer (or across computers), cause the computer(s) to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computerized method of active algorithm training in a sequestered computing node comprising:
processing a data set, within a secure computing node, with the algorithm to generate an algorithm output;
generating a performance model by regression modeling the algorithm output;
routing the performance model to an algorithm developer;
identifying surface regions of the performance model under a configured threshold;
identifying algorithm inputs associated with the identified surface regions; and
performing active learning on the identified algorithm inputs.

2. The method of claim 1, wherein the performance model models at least one of algorithm accuracy, F1 score accuracy, precision, recall, dice score, ROC (receiver operator characteristic) curve/area, log loss, Jaccard index, error, R2 or by some combination thereof.

3. The method of claim 1, wherein the regression modeling includes linear least squares, logistic regression, deep learning or some combination thereof.

4. The method of claim 1, further comprising smoothing the performance model by identifying portions of the performance model which are highly variable.

5. The method of claim 4, wherein the smoothing includes best fit transform, moving averages and application of filters, Loess smoothing, kernel smoothing, wavelets, splines or some combination thereof.

6. The method of claim 5, wherein the smoothing weights the data points of the raw performance model by instances of the algorithm's input variables.

7. The method of claim 1, wherein the algorithm developer receives multiple performance models from the algorithm operating on a plurality of data sets.

8. The method of claim 7, further comprising identifying at least one perturbation in the multiple performance models.

9. The method of claim 1, wherein the active learning includes providing feedback to a data steward to generate more training data for the identified algorithm inputs.

10. The method of claim 9, further comprising performing training on the algorithm in response to the more training data.

11. A computerized system for active algorithm training comprising:
a sequestered computing node residing within a data steward's computing environment, wherein the sequestered computing node remains inaccessible by the data steward, the sequestered computing node configured to process a data set with the algorithm to generate an algorithm output, generate a performance model by regression modeling the algorithm output, and route the performance model to an algorithm developer;
a server within the algorithm developer configured to identify surface regions of the performance model under a configured threshold, and identify algorithm inputs associated with the identified surface regions; and
the data steward configured to perform active learning on the identified algorithm inputs.

12. The system of claim 11, wherein the performance model models at least one of algorithm accuracy, F1 score accuracy, precision, recall, dice score, ROC (receiver operator characteristic) curve/area, log loss, Jaccard index, error, R2 or by some combination thereof.

13. The system of claim 11, wherein the regression modeling includes linear least squares, logistic regression, deep learning or some combination thereof.

14. The system of claim 11, wherein the secure computing node is further configured to smooth the performance model by identifying portions of the performance model which are highly variable.

15. The system of claim 14, wherein the smoothing includes best fit transform, moving averages and application of filters, Loess smoothing, kernel smoothing, wavelets, splines or some combination thereof.

16. The system of claim 15, wherein the smoothing weights the data points of the raw performance model by instances of the algorithm's input variables.

17. The system of claim 11, wherein the algorithm developer receives multiple performance models from the algorithm operating on a plurality of data sets.

18. The system of claim 17, wherein the server further identifies at least one perturbation in the multiple performance models.

19. The system of claim 11, wherein the active learning includes providing feedback to a data steward to generate more training data for the identified algorithm inputs.

20. The system of claim 17, wherein the sequestered computing node is further configured to train the algorithm in response to the more training data.
